(19) United States
(12) Patent Application Publication
(10) Pub. No.: US 2026/0330132 A1
(43) Pub. Date: Oct. 22, 2026

(54) GENERATION OF PRODUCT QUALITY REVIEW REPORT

(71) Applicant: Honeywell International Inc., Charlotte, NC (US)

(72) Inventors: Ankit Singh, Apex, NC (US); Waad Subber, Schenectady, NY (US); Kartikeyan Bollapalli, Bangalore (IN)

(21) Appl. No.: 19/183,950

(22) Filed: Apr. 21, 2025

(51) Int. Cl. G06F 40/186; G06F 16/334; G06F 21/62; G06F 40/279

(52) U.S. Cl. CPC G06F 40/186; G06F 16/3347; G06F 21/6209; G06F 40/279

(57) ABSTRACT

Example techniques for generation of a product quality review (PQR) report are described. In an example, in response to a request to generate the PQR report for a product, previously created reports of a first set of products is accessed. Each of the previously created reports include content pertaining to a predefined quality parameter of the first set of products. Furthermore, the content of the previously created reports are analyzed to identify chapters to be included in the PQR report. Further, for each of the chapters of the PQR report, a list of keywords is generated that specify content to be included in the respective chapters. Furthermore, based on the generated keywords, the content to be included in the chapters of the PQR report is extracted from one or more document management systems. Thereafter, the chapters are populated with the extracted content to generate the PQR report.

### BACKGROUND

In regulated industries, such as pharmaceuticals, medical devices, food production, or the like, compliance with regulatory requirements and industry standards is a critical requirement. Current regulations mandate the preparation and maintenance of documentation to demonstrate compliance with such regulatory requirements and standards for all existing products within these industries. This documentation is commonly referred to as a product quality review (PQR) report. As per the regulatory requirements, manufacturers in such industries are required to prepare PQR reports to evaluate and ensure the consistency of quality of products manufactured over a specific period.

The PQR reports help the manufacturers of the products and regulatory authorities to identify trends, verify the consistency of manufacturing processes, and ensure the correctness of specifications of the products. Additionally, the PQR reports minimize risks that may not be eliminated through testing the finished product alone by documenting manufactured batches, release data, deviations, complaints, recalls, and returned goods. This comprehensive evaluation and documentation that goes into the preparation of the PQR reports not only ensures compliance with the regulatory requirements but also supports continuous improvement in quality and manufacturing practices of the products.

The preparation of a PQR report of a product usually involves analysing vast amounts of data and information pertaining to lifecycle of the product from various sources, such as manufacturing records, quality control test results, customer complaints, and regulatory correspondence. Traditionally, compiling a PQR report has been a labour-intensive process, often requiring manual review and collation of information from numerous documents and databases. This approach is time-consuming and often prone to human error, potentially leading to incomplete or inaccurate PQR report.

In recent years, the use of document management systems (DMSs) has become increasingly common in the preparation of the PQR reports. These DMSs allow for more efficient storage, retrieval, and organization of documents related to the lifecycle of the products. However, the sheer volume of information and the complexity of extracting relevant data for specific sections of the PQR report remain challenging.

### SUMMARY

The details of some embodiments of the invention described in this specification are set forth in the accompanying drawings and the description below. Other features, aspects, and advantages of the invention will become apparent from the description, the drawings, and the claims.

The present subject matter relates to methods, systems, and non-transitory computer-readable media for generating product quality review (PQR) report of a product based on information relating to lifecycle of the product stored in one or more document management system (DMSs) managed by a manufacturer of the product.

In accordance with an embodiment of the present subject matter, a request for generating a PQR report may be received at a quality management system (QMS). Upon receiving the request, a historic data module of the QMS retrieves, from one or more data sources, previously created reports pertaining to lifecycle of a first set of products. Each of the previously created reports include a plurality of chapters and each chapter of the plurality of chapters include content pertaining to a predefined quality parameter of the first set of products. The QMS further includes a first large language model (LLM) module that analyzes the chapters of the previously created reports that are retrieved from the one or more data sources to identify one or more chapters from amongst the plurality of chapters that are to be included in the PQR report of the product. The first LLM module also generates a template of the PQR report of the product. The template prescribes a layout for each of the identified chapters. Furthermore, the QMS includes a second LLM module that generates, for each of the identified chapters of the PQR report, a list of keywords that specify content to be included in the respective chapters. Further, the QMS includes a third LLM module that extracts, from one or more document management systems (DMSs) that include information pertaining to lifecycle of the product, the content based on the generated keywords. The third LLM module maps the extracted content to the respective chapters based on the layout to populate each of the identified chapters to create the PQR report of the product.

In accordance with another aspect of the present invention, the method is implemented in a quality management system (QMS) that manages workflows for generating a PQR report. The method includes receiving, at the QMS, a request to generate the PQR report for a product. The method further includes accessing, from a database associated with the QMS, previously created reports of a first set of products. Each of the previously created reports include a plurality of chapters and each of the plurality of chapters includes content pertaining to a predefined quality parameter of the set of products. Furthermore, the method includes analysing the plurality of chapters of the previously created reports to identify one or more chapters to be included in the PQR report. The method further includes generating a template of the PQR report. The template prescribes a layout for each of the identified chapters. Furthermore, the method includes generating, for each of the chapters of the PQR report, a list of keywords that specify content to be included in the respective chapters. The method also includes extracting, from one or more document management systems (DMSs) that include information pertaining to lifecycle of the product, the content based on the generated keywords. Thereafter, based on the layout, the chapters of the PQR report is populated with the extracted content to generate the PQR of the product.

In accordance with an embodiment of the present invention, the non-transitory computer-readable medium contains instructions that enable a processing resource to define, upon receiving a request to generate a PQR report for a product, a template for the PQR report. The template includes one or more chapters. Each chapter of the template is to include content pertaining to a predefined quality parameter corresponding to the product. In an example, the instructions are executable to generate, for each of the chapters of the PQR report, a list of keywords that specify the content to be included in the respective chapters. In an example, the instructions are executable to access, from one or more data sources, previously created reports of a first set of products. Each of the previously created reports comprises a plurality of chapters, wherein each chapter includes content pertaining to a predefined quality parameter of the first set of products. In an example, the instructions are executable to determine a similarity score between the keywords of the chapters of the PQR report and contents of the chapters of at least one of the previously created reports of the first set of products. The similarity score is indicative of a degree to which the keywords of the chapters of the PQR report are associated with the content of the corresponding chapters of the previously created report. In an example, the instructions are executable to identify a chapter from the previously created report with a similarity score exceeding a predetermined threshold. In an example, the instructions are executable to retrieve a hyperlink associated with the identified corresponding chapter of the previously created report. In an example, the instructions are executable to populate the chapter of the PQR report with the retrieved hyperlink. The hyperlink provides access to an HTML page containing the content relevant to the chapter of the PQR report.

By automatically extracting relevant information pertaining to the lifecare of the product from the DMSs, organizing the extracted information into appropriate chapters, and filling out the PQR report, the present subject matter ensures efficient generating to the PQR report. The present subject matter also ensures data integrity and minimizes the need for extensive manual work for extracting the information pertaining to the lifecycle of the product. This addresses the issues of traditional methods, which often require time-consuming manual compilation of reports from various sources.

Thus, by streamlining the PQR report generation process, the present subject matter helps prevent issues like information oversight or inconsistencies in critical quality parameters during preparing of the PQR report. This ensures the maintenance of product quality, regulatory compliance, and operational efficiency.

Additional features and advantages are realized through the concepts of the present invention, including improved recall management, reduced delays, and enhanced communication efficiency. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques for generating a product quality review (PQR) report, in accordance with an example implementation of the present subject matter;

FIG. 2 illustrates a block diagram of a quality management system (QMS) for generating the PQR report, in accordance with an example implementation of the present subject matter;

FIG. 3 illustrates the QMS for generating the PQR report, in accordance with another example implementation of the present subject matter;

FIG. 4 illustrates a signal flow in a process of generation of the PQR report, in accordance with an example implementation of the present subject matter.

FIG. 5 illustrates a method for generating the PQR report, in accordance with an example implementation of the present subject matter;

FIG. 6 illustrates a flow diagram of a process for authenticating rights of a user to access content for a chapter of the PQR report from document management systems, in accordance with an example implementation of the present subject matter;

FIG. 7 illustrates a flow diagram of a process for generating a list keywords each chapters of the PQR report, in accordance with an example implementation of the present subject matter;

FIG. 8 illustrates a flow diagram of a process for populating the chapters of the PQR report with hyperlinks to provide access to extracted content corresponding to the respective chapters, in accordance with an example implementation of the present subject matter; and

FIG. 9 illustrates a computing environment for generating the PQR report, in accordance with an example implementation of the present subject matter.

In the figures, the left-most digits of a reference number identify the figure in which the reference number first appears. The same numbers are used throughout the drawings to reference like features and components.

### DETAILED DESCRIPTION

In modern manufacturing environments, manufacturers across various industries rely on multiple document management systems (DMS) to store and organize critical information related to lifecycle of products that are manufactured by the manufacturers. Examples of the information relating to the lifecycle of products may include, but are not limited to, manufacturing documents, standard operating procedures, quality manuals, work instructions, change control documentation, audit and inspection reports, training records and manuals, deviations and non-conformances, or the like.

The DMSs typically store information relating to the lifecycle of the products in various formats. This is because the DMSs are designed to capture and store a wide range of information from diverse sources throughout the lifecycle of a product. The information may come from different departments, processes, and equipment, each potentially using its own format or method of data entry. For example, manufacturing data may be stored as batch records, equipment logs may be in spreadsheets, quality control results may be in laboratory information management systems, and customer complaints may be in a separate customer relationship management system.

In regulated industries, such as pharmaceuticals, medical devices, food production, or the like, the information related to the lifecycle of the products is required to be furnished as a part of product quality review (PQR) reports. A “product quality review report” may be understood as a document that provides comprehensive information relating to the quality of a manufactured product by collating information from various stages of the lifecycle of the product, such as information corresponding to raw materials, manufacturing processes, and finished product testing, to identify trends, potential issues, and areas for improvement, ensuring consistent quality and compliance with standards established by regulatory authorities. The regulatory authorities often use the information in the PQR report to make decisions regarding product approval, market authorization, and inspections.

Format in which the PQR reports are to be prepared are generally prescribed by the regulatory authorities, such as the Food and Drug Administration (FDA), European Medicines Agency (EMA), or other relevant national or international regulatory bodies based on types of the products. Accordingly, the manufacturers are required to follow the prescribed format in preparing the PQR report to ensure compliance with regulatory requirements set by the regulatory authorities.

Although the information required to be included in the PQR reports is often available with the DMSs, the PQR reports may not be generated directly from such information. This limitation arises because there is often no correspondence between the structure of the information stored in the DMSs and the format mandated for the PQR reports by the regulatory authorities. For example, the regulatory requirements may specify that information related to the lifecycle of a product be organized into distinct chapters of the PQR reports, with each chapter corresponding to a specific quality parameter of the product. In an example, one chapter may pertain to manufacturing processes, another to deviations and non-conformances, and yet another to stability test results. However, the information regarding the lifecycle of the products stored in the DMSs is typically not organized by quality parameters of the products as required for the PQR reports, and therefore, it may be challenging to directly use the information stored in the DMSs to populate the corresponding chapters of the PQR reports.

Thus, the inconsistent structure of the information pertaining to the lifecycle of the products stored in the DMSs presents significant challenges. While it allows for flexible data storage, such unstructured nature of the information may complicate the process of systematically organizing, locating, managing, and updating specific types of information within each DMS. Moreover, the lack of alignment between the structure of the information pertaining to the lifecycle of the products stored in the DMSs and the format required for the PQR reports significantly contributes to the challenges in generating the PQR reports that are comprehensive, accurate, and compliant with the applicable regulatory requirements. Such inconsistent structure of the information may necessitate extensive manual effort to extract, interpret, and reorganize the relevant information from various DMSs into the standardized format of the PQR reports required for regulatory compliance, increasing the risk of errors, omissions, and inconsistencies in the final PQR report.

Also, the information required for a single PQR report is often dispersed across multiple DMSs, making data retrieval a complex and time-consuming process. This fragmentation may lead to inefficiencies, potential oversights, and inconsistencies in generation of the PQR report.

Furthermore, redundancy across the different DMSs is a common issue. The same or similar information may be stored in the multiple DMSs, creating potential discrepancies and duplicating efforts may be required during compilation of the PQR report. Version control becomes a critical concern, as ensuring the most up-to-date information is used in the PQR report may be challenging when dealing with multiple sources of the information. Also, the varying formats of documents across different DMSs further complicate the process of standardizing information in the final PQR report. This inconsistency makes it challenging to compile a PQR report that adheres to the regulatory requirements.

Access control adds another layer of complexity to the process. Each DMS may have its own set of permissions and access protocols, complicating the task of retrieving information for authorized personnel. This may lead to delays in generation of the PQR reports and potential security risks if not managed properly.

In light of above indicated problems, there is a need for a technique that may intelligently correlate and utilize the information already available in the existing DMSs. Such a solution may be required to be capable of identifying relevant information across multiple DMSs, filtering the relevant information appropriately, and making the relevant information available in the PQR report in the prescribed format. The technique may also be required to be capable of maintaining the integrity and security of the original data sources, without the need for creating an additional database.

To this end, the present subject matter describes techniques for correlating information pertaining to lifecycle of a product stored in document management systems (DMSs) with information required to be included in a product quality review (PQR) report, filtering the information, and making the information available in the PQR report in the prescribed format. The present subject matter addresses the limitations of conventional quality management systems by optimizing the generation of PQR reports, thereby improving efficiency and accuracy in product quality review processes.

The present subject matter may include accessing, by a historic module, from one or more data sources, previously created reports pertaining to lifecycle of a first set of products. Each of these previously created reports comprises a plurality of chapters, with each chapter comprising content pertaining to a predefined quality parameter of the first set of products. For example, in a pharmaceutical context, one chapter (chapter A) may include content related to critical quality attributes of a pharmaceutical product, such as a headache medicine, while another chapter (chapter B) may include content relating to deviations and non-conformances noted during manufacturing of the pharmaceutical product.

Further, the present subject matter employs a first large language model (LLM) module to analyze the plurality of chapters of the previously created reports relating to the lifecycle of the first set of products. This analysis is done to identify one or more chapters from amongst the plurality of chapters of the previously created reports that are to be included in a PQR report of a product. The first LLM module may further generate a template of the PQR report of the product. The template generated by the first LLM module prescribes a layout for each identified chapters of the PQR report.

Furthermore, a second LLM module generates, for each of the identified chapters of the PQR report, a list of keywords that specify content to be included in the respective chapters. The QMS further include a third LLM module that extracts, from one or more document management systems (DMSs) that includes information pertaining to lifecycle of the product, the content based on the generated keywords. The third LLM module further maps this extracted content to the respective chapters based on the layout to populate each of the identified chapters to create the PQR report of the product.

Accordingly, by automatically identifying relevant content from the DMSs, mapping the identified relevant content to appropriate chapters, and populating the PQR report with the identified content, the present subject matter achieves efficient quality management without compromising data integrity or requiring extensive manual intervention. The present subject matter solves the problem of conventional methods of generating the PQR reports that often involve time-consuming manual compilation of the PQR reports from multiple sources. This ensures accurate quality review while providing flexibility to incorporate new information across different aspects of the lifecycle of the product.

Thus, by streamlining the PQR report generation process, the present subject matter enables avoiding issues such as information oversight or inconsistencies in critical quality parameters, thereby maintaining product quality, regulatory compliance, and operational efficacy.

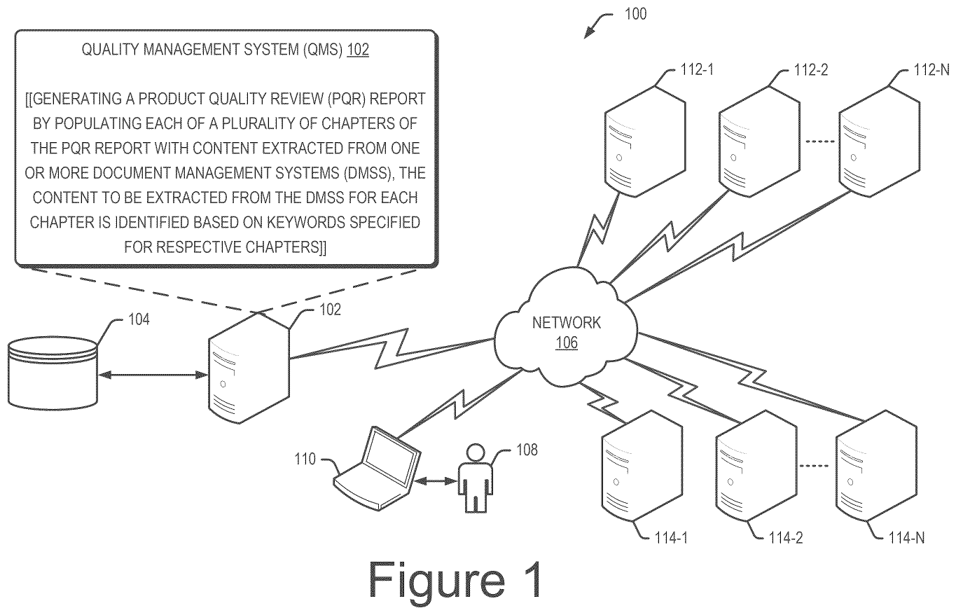

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 for implementing example techniques for the generation of a product quality review (PQR) report that may be used to review the quality and compliance of a product or batches of products with regulatory requirements, in accordance with an example implementation of the present subject matter.

Generating the PQR report often requires populating chapters of the PQR report with relevant content. This process typically involves gathering and analyzing information pertaining to lifecycle of the product stored by manufacturer of the product in various document management systems (DMSs). These DMSs may contain a wide range of documents and data, including batch records, analytical test results, equipment logs, stability study reports, supplier information, regulatory correspondence, or the like. The challenge lies in efficiently extracting the relevant information from these diverse DMSs, which may store data in different formats and structures, and compiling it into a coherent and comprehensive PQR report that meets the regulatory requirements and internal quality standards. A QMS, such as the QMS 102 described in the present subject matter, is a tool that may be used to streamline the process of generating the PQR report by automating the collection, analysis, and organization of relevant information from the various DMSs. By automating these processes, the QMS may help to reduce errors, improve consistency, and significantly decrease the time and resources required to generate comprehensive and compliant PQR reports.

In an embodiment of the present subject matter, the network environment 100 may include the QMS 102 that may be implemented and operated by a manufacturer of the product. Amongst various workflows, the QMS 102 may implement one or more workflows to manage the lifecycle of the product. The QMS 102 may also implement workflows for generation of the PQR report. For example, the QMS 102 may implement workflows for collection of content required to be included in the chapters of the PQR report, generation of the PQR, review processes, and approval procedures related to the PQR report. In an embodiment, data generated by the QMS 102 at each of the stages of the generation of the PQR report may be stored in a QMS database 104. As may be understood the QMS database 104, may be a database associated with the QMS 102 that may store data pertaining to the lifecycle of the product. The data pertaining to the life cycle of the product may comprise, for example, data relating to the conditions of manufacturing of the product, testing of the product, and/or packaging and distribution of the product and so on. The QMS database 104 may be structured to facilitate efficient retrieval and analysis of data for generation of the PQR report and review purposes. The QMS database 104 may include version control mechanisms to track changes and updates to the stored information over time. The QMS database 104 may also implement security measures to ensure data integrity and restrict access based on user roles and permissions within the QMS 102.

In an example, the QMS database 104 may be external to the QMS 102. For example, the QMS database 104 may be implemented as a separate database server accessible by the QMS 102 over a network, such as a network 106. In another example, the QMS database 104 may be internal to the QMS 102. For example, the QMS database 104 may be integrated within the QMS 102 as a local database component. In alternative embodiments, the QMS database 104 may consist of more than one physical device, each holding data corresponding to different stages of the PQR report generation process. For example, one device may store data corresponding to content to be included in the chapter of the PQR report, while another device may store data related to the final compilation and review of the PQR report.

In an example, the network 106 may be a single network or a combination of multiple networks and may use a variety of different communication protocols. The network 106 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 106 includes various network entities, such as gateways, and routers; however, such details have been omitted for the sake of brevity of the present description.

Although the QMS 102 is shown to be implementing the workflows for managing the generation of the PQR report, in some implementations, the workflows for the generation of the PQR report may be implemented by any system associated with the QMS 102. For example, a dedicated module within the QMS 102 may handle tasks related to the generation of the PQR report. In another alternative embodiment, the workflows for managing the generation of the PQR report may be implemented in a separate physical device that operates in conjunction with the QMS 102 to optimize the process of generating the PQR report. For example, an external server may be used to implement the workflows for the compilation of data for the generation of the PQR report, working alongside the QMS 102. Accordingly, example embodiments where a system other than the QMS 102 implementing the workflows for the generation of the PQR report accesses the QMS database 104 either directly or through the QMS 102, for example, through the network 106, are also possible.

In an embodiment, the QMS 102 may incorporate mechanisms for receiving a request for the generation of a PQR report for any product manufactured by the manufacturer. In an example, the request for generating the PQR report may be entered into the QMS 102 by a representative 108 of the manufacturer via a user device 110. Examples of the user device 110 may include, but are not limited to, a desktop computer, a laptop, a tablet, a smartphone, or any other suitable computing device capable of connecting to the network 106 and communicating with the QMS 102. The QMS 102 may be accessible on the user device 110 over the network 106 to receive the request for the generation of the PQR report. For example, the QMS 102 may provide a user interface, for example, a webpage or an electronic form that may be accessed by the representative 108 of the manufacturer, for example, through the user device 110, to issue the request for the generation of the PQR report to the QMS 102. In some embodiments, the QMS 102 may be available locally on the user device 110, allowing for offline functionality and data synchronization when connectivity to the network 106 is established. The QMS 102 may utilize various communication channels, such as email, SMS, or a dedicated portal, to receive the request for the generation of the PQR document. In some examples, an action notification to generate the PQR report may be automatically created in the QMS 102 upon receiving information from the regulatory authorities or when a representative has set a predefined timeline in the QMS to initiate the process of generating the PQR report.

In an embodiment, upon receiving the request to generate the PQR report, the QMS 102 may initiate a workflow to identify relevant chapters and content to be included in those chapters to generate the PQR report that complies with the regulatory requirements.

In an embodiment, in a process to identify relevant chapters of the PQR report, the QMS 102 may access one or more data sources 112-1, 112-2, . . . , and 112-N, for example, over the network 106, to retrieve previously created reports related to lifecycle of a first set of products. In an example, the previously created reports may be PQR reports of the first set of products. For example, the previously created reports may contain information related to other aspects of the lifecycle of the first set of products, including, but not limited to, investigations related to recalls of the first set of products, efficacy and safety of the first set of products, manufacturing processes employed in manufacturing of the first set of products, quality control, conformance and non-conformance records, out-of-specification results, validation outcomes, stability studies, or similar data.

In an example, the data sources 112-1, 112-2, . . . , and 112-N may include, but are not limited to, web pages of third-party vendors, databases of drug and supplement manufacturers, regulatory agencies such as the Food and Drug Administration (FDA), Canadian Food Inspection Agency (CFIA), European Medicines Agency (EMA), or similar organizations. Furthermore, in some examples, the first set of products may relate to the product for which the PQR report is to be generated. For example, if the product for which the PQR report is to be prepared is a pain relief tablet, then the first set of products may include other pain relief formulations, such as pain relief caplets, pain relief liquid suspensions, or extended-release pain relief tablets. In other examples, the first set of products may not be directly related to the product but may fall within a same broad category of medical formulation as the product for which the PQR report is to be generated. For example, if the PQR report is being prepared for the pain relief tablet, the first set of products may be other over-the-counter medications including, for example, cough suppressants or allergy relief medications.

In some examples, if the first set of products are manufactured by the manufacturer of the product in respect of which the PQR report is to be prepared, the previously created reports of the first set of products may be accessed from a database of the QMS 102 as the database of the QMS 102 may contain historical PQR reports, quality control data, manufacturing records, and other relevant documentation specific to product portfolio of the manufacturer.

In an embodiment, each of the previously created reports may include one or more chapters. In an example, each chapter may include a title corresponding to predefined quality parameters of the set of products. For example, if a chapter is to include content related to stability studies of the set of products, then the chapter may be named “stability studies”. Each chapter may include content pertaining to a predefined quality parameter of the first set of products. For example, in case a previously created report pertains to recall investigation in respect of the pain relief tablet, the previously created report may include chapters on product identification, manufacturing process review, quality control test results, deviation analysis, root cause investigation, corrective and preventive actions, regulatory compliance assessment, or the like. Each of these chapters may focus on specific aspects of the product quality and the recall investigation process. The content within each chapter may be structured to provide information about the respective quality parameter. This may include quantitative data, qualitative assessments, historical trends, and comparative analyses. For example, the manufacturing process review chapter may contain content related to batch records, equipment logs, and process validation data. The chapter related to the quality control test results may include analytical data, stability studies, and out-of-specification investigations.

Further, in an embodiment, the QMS 102 may analyze the chapters of the previously created report to identify one or more chapters from amongst the chapters of the previously created report that may be included in the PQR report of the product. For example, if the PQR report to be generated is for the pain relief tablet and if the previously created report is a PQR report for a different variation of the pain relief tablet (e.g., pain relief extra strength), the QMS 102 may identify chapters such as “critical quality attributes,” “deviations and non-conformances,” and “stability studies”, of the previously created PQR report as directly relevant for inclusion in the PQR report for the pain relief tablet. The “critical quality attributes” chapter may be identified to be relevant as it is likely to cover common content such as active ingredient content, dissolution rate, and impurity levels, which are crucial for all pain relief variations. Similarly, the “regulatory compliance” chapter may also be identified to be relevant as it may include content related to adherence to good manufacturing practices (GMP), compliance with specific regulatory guidelines for over-the-counter pain relievers, and any recent regulatory updates or inspections relevant to pain relief products. This chapter may include content that cover aspects such as labeling requirements, packaging standards, and any specific regulatory commitments or post-marketing surveillance requirements that apply across different pain relief formulations.

Furthermore, once the chapters that are to be included in the PQR report of the product are identified, the QMS 102 may generate a template of the PQR report. In an example, the template may prescribe a layout of each of the identified chapters. Once the template of the PQR report of the product is finalized, the QMS 102 may proceed to initiate the workflow for populating the chapters of the PQR report with respective contents.

In doing so, in an embodiment, the QMS 102 may generate, for each of the identified chapters of the PQR report, a list of keywords that specify the content to be included in the respective chapters. In an embodiment, the QMS 102 may access one or more document management systems (DMSs) 114-1, 114-2, . . . , 114-N to extract the content for the chapters of the PQR report based on the generated keywords. In an example, the DMSs 114-1, 114-2, . . . , 114-N may include various internal and external repositories of quality-related documents and data that encompass information pertaining to the lifecycle of the product. These DMSs 114-1, 114-2, . . . , 114-N may include internal quality management databases storing batch records and deviation reports, Laboratory Information Management Systems (LIMS) containing analytical test results, electronic document repositories housing standard operating procedures (SOPs), regulatory submission archives, Enterprise Resource Planning (ERP) systems with manufacturing data, complaint management systems, and third-party manufacturer portals. The DMSs 114-1, 114-2, . . . , 114-N may also contain documents related to product development, technology transfer, scale-up activities, process validation, ongoing stability studies, post-market surveillance, and product discontinuation or phase-out plans.

In an embodiment, the QMS 102 may map the extracted content to the respective chapters of the PQR report based on the layout to populate each of the identified chapters of the PQR report and create the PQR report of the product.

Accordingly, the present subject matter optimizes the process of generating a PQR report of a product by intelligently correlating desirable content, filtering the content, and making the content available in the appropriate chapters of the PQR report. This automated process minimizes human error, ensures consistency across the PQR report, and reduces the time and effort required for compilation of the PQR report.

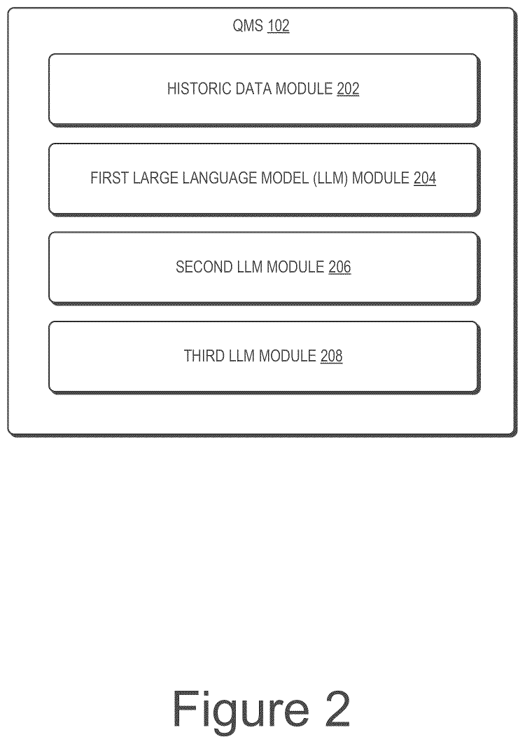

FIG. 2 illustrates the QMS 102 to optimize the process of the generation of the PQR report, in accordance with an example implementation of the present subject matter.

As explained previously, in regulated industries, such as pharmaceuticals, biotechnology, medical devices, food and beverage, or the like, manufacturers may be required to generate a PQR report for their commercialized products. The PQR report may be used by the regulatory authorities to ascertain whether the products meet predefined quality standards and the regulatory requirements. The PQR report typically covers a specific period, usually annually, and provides a systematic review of various quality-related aspects of the product, including manufacturing processes, deviations, complaints, stability data, and any changes implemented during the review period. This PQR report may serve as a critical tool for both the manufacturers and the regulatory authorities to ensure ongoing product quality, safety, and efficacy, as well as to identify trends and opportunities for continuous improvement in the manufacturing and quality control processes.

To ensure that the process of generation of the PQR is efficient, that is, accurate, comprehensive, and timely, the QMS 102 may be used. The QMS 102 may be used to logically correlate the chapters of the PQR report to the content from external sources, such as the DMSs 114-1, 114-2, . . . , 114-N, in preparing the PQR report without requiring significant manual efforts. This automated approach not only streamlines the process but also reduces the potential for human error and inconsistencies that may occur with manual compilation. By mapping relevant content from the DMSs 114-1, 114-2, . . . , 114-N to appropriate chapters of the PQR report, the QMS 102 may ensure that the regulatory authorities receive a well-structured, and thorough review of the quality of a product or batches of products over a specified period. The QMS 102 of the present subject matter also enhances the ability of the manufacturers to demonstrate ongoing compliance, identify trends, and implement continuous improvement measures effectively.

In an example embodiment of the present subject matter, to implement the workflows for generating a PQR report of a product, the QMS 102 includes a historic data module 202. The historic data module 202 may retrieve, from one or more data sources, such as the data sources 112-1, 112-2, . . . , and 112-N, the previously created reports pertaining to the lifecycle of the first set of products. Each of the previously created reports includes a plurality of chapters. Each chapter of the plurality of reports includes content pertaining to a predefined quality parameter of the first set of products. For example, a chapter on “manufacturing process summary” of a previously created report may include content related to batch records, process parameters, and in-process controls. The “critical quality attributes” chapter of the previously created report a may contain analytical test results and trend analyses.

In an embodiment, the QMS 102 may further include a first large language model (LLM) module 204. The first LLM module 204 may analyze the plurality of chapters of the previously created reports to identify one or more chapters from amongst the plurality of chapters that may be included in the PQR report of the product. For example, if the previously created reports are PQR reports of the first set of products that is related to the product for which the PQR report is to be prepared, the first LLM module 204 may analyze content, structure, and relevance of each chapter in these previously created PQR reports. The first LLM module 204 may identify common chapters that are consistently present across the PQR reports of the first set of products, such as the “manufacturing process summary,” “critical quality attributes,” and “stability studies.” In an embodiment, once the chapters that may be included in the PQR report of the product are identified, the first LLM module 204 may generate a template of the PQR report. In an example, the template may prescribe a layout for each of the identified chapters of the PQR report.

In an embodiment, the QMS 102 includes a second LLM module 206. The second LLM module 206 may generate, for each of the identified chapters of the PQR report, a list of keywords that specify content to be included in the respective chapters. For example, for the “manufacturing process summary” chapter, the keywords may include “batch records,” “process parameters,” “in-process controls,” and “yield.” For the “critical quality attributes” chapter, the list of keywords may include “assay results,” “impurity profiles,” and “dissolution rates.” The “stability studies” chapter may have keywords such as “long-term stability data,” “accelerated stability results,” and “out-of-specification investigations.” These keywords may act as search terms or filters when querying the various DMSs 114-1, 114-2, . . . , 114-N, allowing the QMS 102 to efficiently locate and extract pertinent content for each chapter.

In an embodiment, the QMS 102 further includes a third LLM module 208. The third LLM module 208 extract, from the DMSs 114-1, 114-2, . . . , 114-N, the content for the chapters of the PQR report based on the generated keywords respective chapters. Furthermore, the third LLM module 208 maps the extracted content to the respective chapters based on the layout to populate each of the identified chapters to create the PQR report of the product. For example, for the “manufacturing process summary” chapter, the third LLM module 208 may extract batch records and process parameter data using the keywords “batch records” and “process parameters.” The third LLM module 208 may then maps this content to the appropriate sections within the chapter layout, such as placing batch yield data in a designated “yield summary” table and process parameter trends in a “process parameter analysis” section. Similarly, for the “stability studies” chapter, the third LLM module 208 may extract long-term and accelerated stability data using relevant keywords, then map this content to predefined stability data tables and trend analysis graphs within the chapter layout. This intelligent extraction and mapping process ensures that each chapter is populated with relevant, structured content that adheres to the predefined layout, resulting in a comprehensive and well-organized PQR report.

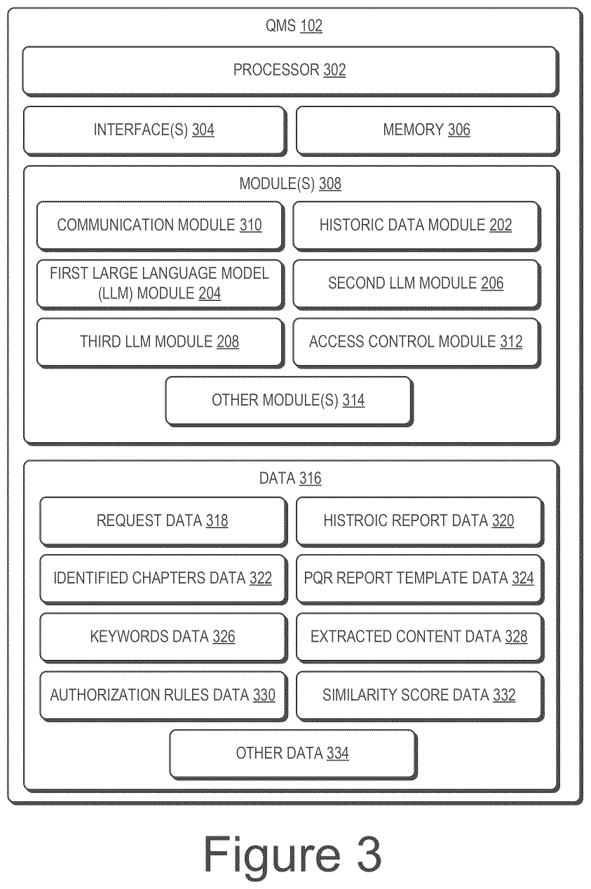

Accordingly, the present subject matter allows for generating a comprehensive and efficient PQR report by intelligently extracting and organizing relevant information from multiple DMSs. This reduces manual effort, minimizes the risk of overlooking critical data, and streamlines the PQR report generation process. The present subject matter ensures that each chapter of the PQR report is populated with the most relevant and up-to-date information, improving the overall quality and accuracy of the PQR report. This automated approach not only saves time but also enhances consistency across PQR reports and facilitates easier regulatory compliance. To elaborate on the functionality of the QMS 102 to optimize the PQR report generation process based on the intelligent content extraction and mapping, reference is made to FIG. 3.

FIG. 3 illustrates the QMS 102 that optimizes the process of generation of the PQR report for a product or batches of products, in accordance with another example implementation of the present subject matter.

In an example, the QMS 102 depicted in FIG. 3 may be any computing device. Examples of the QMS 102 may include but are not limited to servers, desktop computers, laptops, smartphones, personal digital assistants (PDAs), and tablets.

In an embodiment, the QMS 102 may include a processor 302. In an example, the processor 302 may be implemented as microprocessors, microcomputers, microcontrollers, digital signal processors, central processing units, state machines, logic circuitries, and/or any devices that manipulate signals based on operational instructions. The QMS 102 may also include interface(s) 304. The interface(s) 304 may include a variety of software and hardware interfaces that allow interaction of the QMS 102 with other communication and computing devices, such as network entities, web servers, external repositories, and peripheral devices, such as input/output (I/O) devices. For example, the interface(s) 304 may couple the QMS 102 with the DMSs 114-1, 114-2, . . . , 114-N and the user device 110 the representative 108 of the manufacturer. The interface(s) 304 may also enable coupling of internal components, if any, of the QMS 102 with each other.

Further, in an embodiment, the QMS 102 may include a memory 306 coupled to the processor 302. The memory 306 may include any computer-readable medium known in the art including, for example, volatile memory (e.g., RAM), and/or non-volatile memory (e.g., EPROM, flash memory, etc.). The memory 306 may also be an external memory unit, such as a flash drive, a compact disk drive, an external hard disk drive, or the like. The QMS 102 may include module(s) 308 and data 316 coupled to the processor 302.

Furthermore, in an embodiment example, the module(s) 308 and data 316 may reside in the memory 306. In an example, the data 316 may include request data 318, historic report data 320, identified chapters data 322, PQR report template data 324, keywords data 326, extracted content data 328, authorization rules data 330, similarity score data 332, and other data 334. The data 316 serves, amongst other things, as a repository for storing data that may be fetched, processed, received, or generated by one or more of the module(s) 308 of the QMS 102. It may be further noted that information stored and available in the data 316 may be utilized by the QMS 102 for executing the workflows for generating the PQR report of a product, for example, to comply with the regulatory requirements.

In an example, the module(s) 308 may include routines, programs, objects, components, data structures, and the like, which perform particular tasks or implement particular abstract data types. The module(s) 308 further includes modules that supplement applications on the QMS 102, for example, modules of an operating system. In an example, the module(s) 308 may include a communication module 310, the historic data module 202, the first LLM module 204, the second LLM module 206, the third LLM module 208, an access control module 312, and other module(s) 314. The other module(s) 314 may include programs or coded instructions that supplement applications and functions, for example, programs in the operating system of the QMS 102.

In an embodiment, a request to generate a PQR report for a product may be received at the communication module 310 of the QMS 102, for example, from the representative 108 of the manufacturer of the product. In an example, the communication module 310 may provide a under interface using the interface 304 to allow users, for example, representative 108 of the manufacturer to provide the request.

The generation of the PQR report may be required to comply with the regulatory requirements associated with the manufacturing and commercialization of the product. For the purposes of the present description, any reference made to a product for which the PQR report is to be generated may encompass a single product, a specific set or batch of the product, or multiple sets or batches of products that have been manufactured by the manufacturer for distribution and use by end consumers. For example, if the request is for a PQR report of a specific pharmaceutical drug, the request for the generation of the PQR report may pertain to a single batch of the drug produced within a specific timeframe or multiple batches manufactured over a predefined period, for example, in a year. Similarly, for a nutritional supplement or medical device, the PQR report may cover a single product variant, or a range of similar formulations or models produced under the same manufacturing and quality control standards. In an example, the request may specify information related to the product for which the PQR report is to be generated. For example, the request may include details such as the product name, batch number(s), manufacturing date, expiry date, regulatory classification, intended market, and any specific quality or compliance parameters that need to be addressed in the PQR report. Additionally, the request may indicate whether the PQR report is to be generated for a single batch of the product, multiple batches, or an entire product line. By including such details, the QMS 102 may be enabled to efficiently retrieve and compile the necessary content for the PQR report, ensuring that the PQR report is generated in accordance with the regulatory guidelines and industry best practices. The information received with the request for the generation of the PQR report may be stored in the data 316 as the request data 318.

Upon receipt of the request for the generation of the PQR report for the product, the chapters that are to be included in the PQR report may be identified. This is because the regulatory guidelines may require that quality parameters of the product and other information be systematically categorized within the PQR report in the form of the chapters. While the regulatory guidelines may outline the content that is to be included in the PQR report, such as content on manufacturing consistency, stability studies, deviations, corrective actions, quality control measures, and compliance records, the regulatory guidelines regarding the generation of the PQR report may not explicitly define the chapters under which such contents should be organized. As a result, a reference to the previously created reports may be made to identify the chapters of the PQR report to ensure compliance with the regulatory guidelines while streamlining the PQR report generation process. In some cases, the representative 108 of the manufacturer may define the chapters of the PQR report based on the prescribed format of the PQR report set forth by the regulatory authorities.

In an embodiment, the historic data module 202 may access the data sources 112-1, 112-2, . . . , and 112-N to retrieve the previously created reports of the first set of products. The historic data module 202 may include a large language model (LLM) trained specifically for this task. In an example, the first set of products may be related to the product for which the PQR report is to be prepared. For example, if preparing a PQR report for a new formulation of an antihypertensive medication, the LLM of the historic data module 202 may retrieve the previously created reports for other antihypertensive drugs or other formulations with the same active ingredient.

In another example, the first set of products may not be directly related to the product for which the PQR report is to be generated; however, the first set of products may fall within the same broad category of products. In other words, while the first set of products and the product for which the PQR report is to be generated may differ in their specific application or composition, both may share common manufacturing processes, regulatory requirements, or quality control standards with the product under evaluation. For example, when generating a PQR report for a novel biologic drug, the LLM may retrieve the previously created reports of other biologic products with similar manufacturing processes or quality control requirements, even if they target different therapeutic areas.

In an example, the previously created reports may be the PQR reports of the first set of products. In another example, the previously created reports may be reports other than the PQR reports that may include information that may be used to identify the chapters to be included in the PQR report of the product. For example, the LLM of the historic data module 202 may analyze annual product reviews, process validation reports, stability study reports, or recall investigation reports, which often contain sections analogous to the chapters of the PQR report, such as manufacturing summaries, quality attribute analyses, and stability data. In the case of a recall investigation report, it may include detailed information on product quality issues, root cause analysis, and corrective and preventive actions (CAPAs) taken. This information may be used for populating the chapters, such as “product quality review” and “corrective and preventive actions”, of the PQR report, providing insights into past quality issues and how they were addressed to prevent recurrence.

In an example, to retrieve the relevant previously created reports, the LLM of the historic data module 202 may rely on the request data 318 received with the request for generating the PQR report of the product. For example, if the request data 318 includes information such as the product type (e.g., small molecule drug, biologic), dosage form (e.g., tablet, injectable), or therapeutic area (e.g., cardiovascular, oncology), the LLM of the historic data module 202 may use these parameters to identify and retrieve the most relevant previously created reports from the data sources 112-1, 112-2, . . . , and 112-N, ensuring that the retrieved information applies to the current PQR report being generated.

In an embodiment, the data sources 112-1, 112-2, . . . , and 112-N may include publicly available data sources, third-party data sources, or the database of the QMS 102, such as the above-explained QMS database 104, maintained by the manufacturer of the product. In an example, the information regarding the previously created report accessed from the data sources 112-1, 112-2, . . . , and 112-N may be stored in the data 316 as the historic report data 320 for further processing.

In an embodiment, once the previously created reports are obtained, the first LLM module 204 may analyze the chapters of the previously created reports to identify one or more chapters that may be included in the PQR report for the product. In doing so, an LLM of the first LLM module 204 may process and evaluate the content of these previously created reports, for example, using natural language processing (NLP) techniques, to extract and categorize relevant chapters based on the regulatory guidelines, industry best practices, and historical patterns.

In an example, to identify the relevant chapters for the PQR report for the product from the previously created reports, the first LLM module 204 may compare the structure of the previously created reports to determine common and essential chapters, assess the context of each chapter to ensure alignment with the regulatory requirements, product specifications, and manufacturing data, and generate recommendations for the chapters that may be included in the PQR report of the product. For example, if the previously created reports for similar products contain chapters on manufacturing consistency, stability studies, deviations, corrective actions, and conformance to specifications, the first LLM module 204 may identify these as commonly included chapters and suggest their inclusion in the PQR report for the product.

Additionally, if the first LLM module 204 detects that certain previously created reports included an adverse event analysis due to product recalls or regulatory audits, the first LLM module 204 may recommend incorporating a similar chapter if relevant. This approach ensures completeness, compliance, and consistency with existing documentation standards for the PQR reports while reducing the manual effort required to define the structure of the PQR report.

In an embodiment, the representative 108 of the manufacturer may vet the chapters identified by the first LLM module 204 and either modify or remove chapters identified for inclusion in the PQR report by the first LLM module 204. For example, if the first LLM module 204 identifies a chapter on adverse event analysis, but the product has not been associated with any reported adverse events, the representative 108 may choose to remove or revise the chapter to ensure relevance.

In some embodiments, the representative 108 may also define additional chapters based on internal guidelines of the manufacturer. For example, while the first LLM module 204 may suggest chapters to be included in the PQR report based on patterns identified in the previously created reports, the manufacturer may have an internal requirement to include a chapter on supply chain risk assessment or raw material quality trends, which is not explicitly mandated by the regulatory guidelines but is considered essential for internal audits.

Additionally, in an embodiment, if the regulatory authorities introduce new regulatory requirements for the product that may not be present in the previously created reports, the representative 108 may add a new chapter to ensure compliance with those specific regulatory requirements. For example, if a regulatory authority, such as the FDA, introduces a new requirement mandating the inclusion of product traceability data in the PQR reports, the representative 108 may add a chapter for addressing traceability measures, batch tracking, and supply chain verification. Similarly, if new environmental or sustainability compliance regulations require the manufacturers to report on carbon footprint, waste management, or energy efficiency in the production process, the representative 108 may include a chapter dedicated for including content relating to these aspects. In an example, the information corresponding to the chapters to be included in the PQR report may be stored in the data 316 as the identified chapters data 322.

In an embodiment, once the chapters to be included in the PQR report are identified, the first LLM module 204 may generate the template of the PQR report. In an example, the template prescribes the layout for each of the identified chapters, providing a structured framework for organizing the PQR report. The layout may be indicative of how the chapters should be arranged within the PQR report, for example, to comply with the regulatory guidelines. For example, the chapters that are mandated by the regulatory guidelines, such as those required by the FDA, EMA, or CFIA, may precede the chapters included for internal quality review purposes by the manufacturer. This ensures that the PQR report meets the regulatory requirements standards first, followed by any additional chapters tailored to internal assessments.

In another example, logically connected chapters may be placed in close proximity to enhance readability and coherence of the PQR report. For example, a chapter on manufacturing consistency may be arranged next to chapters on deviations, out-of-specification results, and corrective and preventive actions, as these chapters are interrelated and contribute to a comprehensive understanding of the product quality. By structuring the PQR report in this manner, it may be ensured that the PQR report is systematic, well-organized, and aligned with both the regulatory requirements and internal quality management practices. In an example, the template generated by the first LLM module 204 may be stored in the data 316 as the PQR report template data 324.

Once the template of the PQR report is generated, the content to be included in the chapters of the PQR report may be identified. For the purpose, in an embodiment, the second LLM module 206 may generate, for each of the identified chapters, a list of keywords that specify the content to be included in the respective chapters. In an example, to generate the list of the keywords, the second LLM module 206 may include an LLM that may be trained to receive, as a user input, a set of descriptors corresponding to each chapter of the PQR report. In an example, the descriptors may be indicative of key topics for which the content is to be included in each chapter of the PQR report. For example, for the “manufacturing process review” chapter, the descriptors may include topics such as “what is process validation status,” “what are critical process parameter trends,” “what is equipment performance review,” “what are in-process control results,” and “report on batch yield analysis.” These descriptors may encapsulate the essential content that needs to be included in the “manufacturing process review” chapter, guiding the LLM to generate more specific keywords such as “validation protocol deviations,” “control chart analysis of critical parameters,” “equipment calibration and maintenance records,” “in-process testing results and trends,” and “root cause analysis of low-yielding batches.” By using these descriptors as a starting point, the second LLM module 206 may ensure that the generated keywords comprehensively cover all crucial aspects of the manufacturing process review, aligning with the regulatory expectations and industry best practices.

In an embodiment, the set of descriptors may be provided by a user responsible for respective chapters of the PQR report. In some examples, one user may be responsible for handling content of more than one chapter. For example, a quality assurance manager may be responsible for both “quality control testing” and “stability studies” chapters, providing descriptors for both chapters simultaneously. In an example, the users responsible for handling the content of the chapters may be experts in a particular field. For example, a formulation scientist may be responsible for “product composition” chapter, while a regulatory affairs specialist may handle “regulatory actions” chapter.

In an embodiment, the second LLM module 206 may analyze the received set of descriptors to extract phrases from the set of descriptors that are relevant to the content to be included in the corresponding chapter. For example, for “deviations and investigations” chapter, the second LLM module 206 may extract phrases like “out-of-specification results,” “root cause analysis,” and “corrective actions” from the provided descriptors. The second LLM module may generate the list of keywords for each chapter based on the extracted phrases. For example, for the “stability studies” chapter, the generated list of keywords may include “long-term stability,” “accelerated conditions,” “shelf life,” and “degradation products.”

In some embodiments, the second LLM module 206 may have a flexibility to dynamically look up the content already created for one or more of the chapters of the PQR report. For example, when generating descriptors for the “stability studies” chapter, the LLM may review the descriptors and keywords already used in the “manufacturing process review” chapter. If the “manufacturing process review” chapter included descriptors such as “process changes” or “new equipment implementation,” the LLM may automatically incorporate related descriptors in the “stability studies” chapter, such as “what is stability impact of process changes” or “show comparative stability data for batches manufactured with new equipment.” This ensures that important aspects highlighted in one chapter are appropriately addressed in related chapters. For example, if the “product quality review” chapter used descriptors related to “out-of-specification results,” the second LLM module 206 may automatically include descriptors like “stability trends of batches with OOS results” in the “stability studies” chapter. By leveraging descriptors across chapters, the second LLM module 206 may identify correlations and ensure that relevant aspects of product quality are examined throughout the PQR report. This approach helps maintain consistency, reduces the risk of overlooking important connections between different aspects of product quality, and enhances the overall depth and quality of the analysis provided in the PQR report.

In some other alternative embodiments, the second LLM module may search a repository of questions most relevant to a current chapter for which the LLM is generating the set of keywords. This repository may reside inside the database of the QMS 102 and be based on industry standards, history of audits, or specific context. For example, when generating content for the “manufacturing process review” chapter, the second LLM module 206 may access the repository of questions based on recent FDA guidance documents on process validation, ICH Q10 guidelines on pharmaceutical quality systems, and historical audit findings related to manufacturing processes. Based on this repository of questions, the second LLM module 206 may generate questions such as: “Have there been any significant changes to the manufacturing process since the last review?”, “What are the trends in critical process parameters across batches?”, “How have any deviations from standard operating procedures been addressed?”, “What is the current status of process validation activities?”, and “Are there any ongoing process improvement initiatives?” These questions may help guide the content generation for the chapter, ensuring that all relevant aspects of the manufacturing process are covered in accordance with current regulatory expectations and industry best practices. The second LLM module 206 may then use these questions to generate appropriate descriptors and keywords for the chapter, which may be further refined by user input.

In some examples, the second LLM module 206 may be prompted, for example, by a user of a chapter, with question regarding the chapter, such as “What are some questions that this chapter is answering?”. The second LLM module 206 may generate responses based on the appropriate context about the manufacturer. The second LLM module 206 may then present a list of descriptors to the user, and the user of the chapter may select either all or a subset of the descriptors from this list. For example, when generating descriptors for the “product quality review” chapter, the second LLM module 206 may present questions such as “How consistent is product quality across batches?” or “What are the trends in critical quality attributes?” along with corresponding descriptors like “batch-to-batch consistency” and “critical quality attribute trends.” The user may then select relevant descriptors from this list, such as the “batch-to-batch consistency,” “critical quality attribute trends,” and “deviation and OOS summary,” which the second LLM module 206 may use to generate the final list of keywords for the chapter. By leveraging this interactive process, the second LLM module 206 may generate more targeted and relevant descriptors, leading to a more comprehensive and accurate PQR report. Therefore, a user of a chapter may receive descriptors relevant to the content to be included in the chapter from the second LLM module 206 by providing the LLM with appropriate context about the manufacturer, without necessarily having to manually enter the descriptions themselves. The LLM may present the user with a list of questions along with relevant descriptors to guide the user in selecting relevant keywords that may specify the content to be included in the chapter. The user may then select either all or a subset of the descriptors from this list, ensuring that the content included is both accurate and aligned with the required standards. This process reduces the need for manual input, streamlining the report generation process while allowing the user to tailor the content to the specific needs of the product or manufacturer. In an example, the list of keywords generated by the second LLM module 206 may be stored in the data 316 as the keywords data 326.

Based on the list of keywords, the content to be included in the respective chapters of the PQR report may be extracted from the DMSs 114-1, 114-2, . . . , 114-N. In doing so, in an embodiment, the third LLM module 208 may access information pertaining to the lifecycle of the product stored within these DMSs 114-1, 114-2, . . . , 114-N. In a process of extracting the content for the chapter of the PQR report, the third LLM module 208, for example, using an LLM, may first convert the lifecycle information accessed from the DMSs 114-1, 114-2, . . . , 114-N into a vectorized dataset for enabling efficient semantic search and retrieval. In an example, third LLM module 208 may query the vectorized dataset to extract the content that is relevant to the identified chapters of the PQR report based on the semantic similarity between the information regarding the lifecycle of the product stored in the vectorized dataset and the keywords specifying the content to be included in the respective chapters. This ensures that the extracted content is contextually aligned with the requirements of the PQR report, improving accuracy and relevance.

In an example, the information regarding the lifecycle of the product in the vectorized dataset may be indexed, for example, based on a strategy defined by the manufacturer. In an example, the information regarding the lifecycle of the product in the vectorized dataset may be indexed according to a hierarchy defined by the manufacturer. This indexing strategy may be based on various parameters, such as organizational structure, geographic location, product category, or manufacturer-specific classification. For example, the information regarding the lifecycle of the product may be arranged based on manufacturing sites, departmental divisions, regulatory jurisdictions, or manufacturer usage patterns. The proper indexing of the information regarding the lifecycle of the product ensures that when the third LLM module 208 attempts to retrieve the content for the chapters of the PQR report, the LLM may efficiently search the appropriate indexes in the vectorized dataset to find matching vectors, thereby significantly reducing lookup time and improving retrieval accuracy.

In an example, the vectorized dataset may remain within the respective DMSs 114-1, 114-2, . . . , 114-N without the need to create a new separate database for storing the vectorized data. This helps in maintaining data integrity, minimizing storage redundancy, and ensuring that the information remains securely managed within the existing DMSs 114-1, 114-2, . . . , 114-N while still being accessible for efficient processing by the QMS 102. In an example, the content for the chapters extracted by the third LLM module 208 may be stored in the data 316 as the extracted content data 328. In an embodiment, the third LLM module 208 may map the extracted content data 328 to the respective chapters based on the layout to populate each of the identified chapters of the PQR report to generate the PQR report.

In an embodiment, the LLMs used for different modules of the QMS 102 may be distinct and specialized for their respective tasks. For example, the LLM for the historic data module 202, the first LLM module 204, the second LLM module 206, and the third LLM module 208 may each be different, with each model trained specifically to handle the unique functionalities of its respective module. In another embodiment, a single LLM may be trained to perform the tasks of each module. In an example, the choice between using separate LLMs or a single unified LLM may depend on factors such as system architecture, computational efficiency, and the level of specialization required for each module.

In an embodiment, the access control module 312 may be responsible for managing and controlling access to each chapter of the PQR report by one or more users, for example, based on predefined authorization rules that is stored in the data 316 as the authorization rules data 330. This ensures that only authorized user may view, edit, or approve specific chapters of the PQR report, thereby maintaining data integrity and security. In an example, access to a chapter of the PQR report by a user may depend on a role of the user within an organization. For example, a quality assurance (QA) specialist may have permission to review and edit chapters related to quality control, deviations, and corrective actions, whereas a regulatory affairs officer may be authorized to access and validate chapters pertaining to compliance and regulatory submissions. Similarly, a production manager may access to manufacturing-related chapters but may not have editing rights over regulatory compliance chapters. Additionally, in an example, the access control may be further refined based on hierarchical levels, departmental affiliations, or project-specific assignments. For example, senior management or auditors may have read-only access to the entire PQR report, while line-level employees may be restricted to only specific chapters relevant to their responsibilities.

Furthermore, in an embodiment, the access control module 312 may also control access to the information stored in the DMSs 114-1, 114-2, . . . , 114-N by the one or more users, based on the predefined authorization rules. In doing so, the access control module 312 may ensure that the permissions associated with an identity of a user while handling a specific chapter of the PQR report align with the access permissions set granted to the user within the corresponding DMSs 114-1, 114-2, . . . , 114-N from which the content is being accessed. This means that even if there are semantic similarities between the information stored in the DMSs 114-1, 114-2, . . . , 114-N and the content required for a specific chapter of the PQR report, the user may only be able to view or extract content that they are authorized to access. If a user does not have permission to access certain information in a source DMS, the user may be restricted from retrieving, viewing, or automatically incorporating that content into the chapter of the PQR report the user is handling. Similarly, if the information in the source DMS is classified or restricted for certain roles, the access control module 312 may prevent any unauthorized transfer of such data into the chapters of the PQR report. For example, if a QA analyst working on a “stability study” chapter of the PQR report does not have access to manufacturing deviation records stored in a specific DMS, then even if the third LLM module 208 identifies a relevant correlation between the stability study results and the manufacturing deviations, the QA analyst may not be able to retrieve or view those records. Conversely, a compliance officer with appropriate access permissions may have the ability to review both sets of information, ensuring that the final PQR report aligns with internal policies and the regulatory requirements. Accordingly, while doing vector lookup in the vectorized dataset, the indexes where the user does not have permissions to access the content, are omitted from the semantic search by the access control module 312. By enforcing these access control measures, the access control module 312 upholds data confidentiality, prevents unauthorized access, and ensures that the users only work with the information they are permitted to handle, maintaining the integrity and security of both the PQR report and the DMSs 114-1, 114-2, . . . , 114-N.

In some situations, in addition to or in lieu of displaying the content directly within a chapter of the PQR report, there may be provided a direct access to the original content. For example, regulatory audits or internal quality reviews may require evidence supporting the content included in the PQR report, such as source documents, test reports, or validation records. Providing access to the original content helps maintain transparency, accuracy, and compliance with regulatory requirements while enabling users to verify the information at its source rather than relying solely on extracted content within the chapter. Additionally, in cases where certain content is relevant to multiple chapters, it may be more efficient to store it separately and reference it rather than duplicating it across multiple sections. For example, a stability study summary may apply to various chapters of the PQR report, and instead of repeating it in each chapter, it may be stored in a central location and linked accordingly. Also, there may be a situation where the PQR report for the product is generated at multiple instances, for example, to submit two different regulatory authorities in their respective formats.

To facilitate this, in an embodiment, the third LLM module 208 may generate, for each instance of the content extracted for the identified chapters of the PQR report from the DMSs 114-1, 114-2, . . . , 114-N, an HTML page containing the extracted content. The third LLM module 208 may then store these HTML pages in a location accessible by the QMS 102. For instance, the HTML pages corresponding to the extracted content may be stored in the QMS database 104.

Furthermore, the LLM may create hyperlinks to each of the stored HTML pages and populate the identified chapters with one or more hyperlinks. Each hyperlink provides access to the corresponding HTML page containing the extracted content, allowing the users of the chapters to retrieve the original information whenever needed. For example, if multiple chapters require reference to a deviation investigation report, instead of embedding content regarding the same report repeatedly, a single HTML page may be created for the report, and hyperlinks to it may be placed in all relevant chapters. This approach helps maintain consistency, eliminates redundancy, and ensures that any updates to the content are automatically reflected across all references. As a result, it improves overall efficiency, accuracy, and traceability within the PQR report and other related documents while ensuring seamless access to critical information.

In certain embodiments, the content within the chapters of previously created reports may be relevant to the chapters of the PQR report for the product. For example, if a previously created report pertains to a product that falls within the same broad category of medical formulations as the product for which the PQR report is to be generated, then the content of one or more chapters from the previously created report may be utilized in one or more chapters of the PQR report of the product.

In such embodiments, to generate the PQR report for the product, the third LLM module 208 may analyze the content of the previously created reports and determine a similarity score between the keywords of the identified chapters of the PQR report and the content of the corresponding chapters in at least one of the previously created reports. In an example, the calculated similarity score may be stored in the data 316 as the similarity score data 332. The similarity score may indicate the degree to which the keywords of the chapters in the PQR report align with the content of the respective chapters in the previously created reports. If the similarity score for a particular chapter exceeds a predetermined threshold, the third LLM module 208 may identify that chapter as relevant and retrieve a hyperlink associated with the identified chapter. This hyperlink may then be included in the corresponding chapter of the PQR report, providing direct access to the original source of information. For example, if a previously created report contains a stability study summary for a formulation with a similar composition, storage conditions, and manufacturing processes as the current product, the third LLM module 208 may determine that the content is relevant based on the similarity score. If the similarity score exceeds the predefined threshold, the LLM module may retrieve a hyperlink to the stability study summary and embed it within the respective chapter of the PQR report. This allows the content to be directly referenced without the need to extract it from the DMSs 114-1, 114-2, . . . , 114-N, thereby reducing dependency on real-time data retrieval and leveraging previously created reports as a reliable source of information for the PQR report of the product.

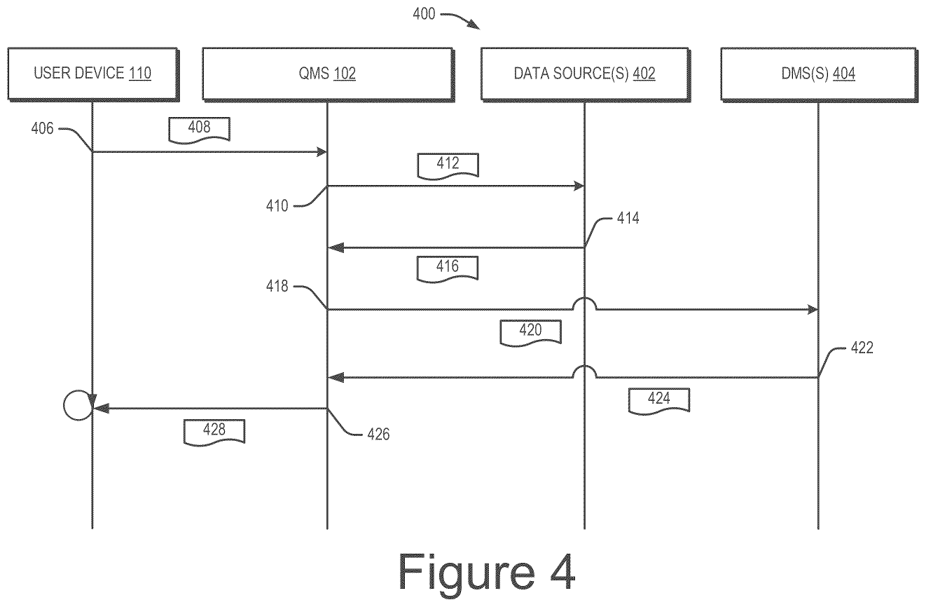

FIG. 4 illustrates a signal flow 400 in a process to generate a PQR report for a product or batches of product that may be used by the regulatory authorities to ascertain whether the product meets the predefined quality standards and the regulatory requirements, according to an example implementation of the present subject matter.

As described in reference to FIGS. 1-3, in regulated industries such as pharmaceuticals, biotechnology, medical devices, or the like, there may be a regulatory requirement to prepare the PQR report for products manufactured in such industries. The PQR report may be used by the regulatory authorities to assess the consistency of the manufacturing process, verify compliance with good manufacturing practices, and ensure the overall quality and safety of the products. Additionally, the PQR report may be beneficial for the manufacturers of the products in such regulated industries by providing insights into process improvements, identifying potential risks, and ensuring continuous quality monitoring.

As explained previously, the QMS 102 may provide a mechanism to correlate the content required in the chapters of a PQR report of a product from the DMSs, such as the DMSs 114-1, 114-2, . . . , 114-N, filter the content based on relevance and regulatory compliance, and make the content available in the appropriate chapters of the PQR report. This automated approach may significantly reduce the manual effort required in data collection, validation, and report compilation, thereby improving efficiency, accuracy, and compliance in the PQR report generation.

In an example implementation of the present subject matter, as indicated in step 406, a request 408 to generate a PQR report for a product may be received at the QMS 102, for example, from the representative 108 of the manufacturer of the product. In an example, the QMS 102 may be accessible to the representative 108 on the user device 110 allowing the representative 108 to raise the request 408.

As explained previously, upon receiving the request 408 to generate the PQR report of the product, the QMS 102 may need to identify the chapters that are to be included in the PQR report of the product. To do so, in an embodiment, the QMS 102, as indicated in step 410, may send an access request 412, for example, over the network 106, to access one or more data sources 402 to obtain the previously created reports pertaining to the lifecycle of the first set of products. As explained previously, each of the previously created reports may include a plurality of chapters and each of the plurality of chapters may include content pertaining to a predefined quality parameter of the first set of products. In an example, the data sources 402 may be similar to the data sources 112-1, 112-2, . . . , and 112-N explained in reference to FIGS. 1-3.

In an embodiment, as indicated in step 414, outcome data 416 corresponding to the previously created report identified from executing access request 412 on the query on the data sources 402 may be received at the QMS 102. In an embodiment, the QMS 102 may analyze the outcome data 416 corresponding to the previously created reports to identify the chapters from amongst the plurality of chapters of the previously created reports to be included in the PQR report of the product. The QMS 102 may further generate a template of the PQR report. In an example, the template may prescribe a layout for each of the identified chapters of the PQR report. In an embodiment, the QMS 102 may further generate, for each of the identified chapters of the PQR report, a list of keywords that specify the content to be included in the respective chapters of the PQR report.

In an embodiment, as indicated in step 418, a retrieval request 420 may be sent by the QMS 102 to one or more document management systems (DMSs) 404 of the manufacturer of the product, that store the information pertaining to the lifecycle of the product, to extract the content for the chapters of the PQR report based on the generated keywords. In an example, the DMSs 404 may be similar to the DMSs 114-1, 114-2, . . . , 114-N explained in reference to FIGS. 1-3. In an embodiment, as indicated in step 422, the content 424 extracted from the DMSs 404 may be received at the QMS 102. In an example, once the content 424 that may be relevant for the chapters of the PQR report is received at the QMS 102, the QMS 102 may proceed to populate the chapters of the PQR report with the respective content. In doing so, the QMS 102 may map the extracted content to the respective chapters of the PQR report based on the layout to populate each of the identified chapters to generate the PQR report of the product.

In an embodiment, once the generated PQR report is reviewed and approved by the respective users of the chapters, the same may be made accessible to the representative 108 of the manufacturer, for example, on the user device 110 of the representative, as a response data 428, as indicted in step 426.

Accordingly, the present subject matter facilitates the retrieval of relevant content from the DMSs 404 and organizes the content into respective chapters of the PQR report. Furthermore, the present subject matter also contributes to cost efficiency by reducing the labor hours typically associated with manual data collection, validation, and report preparation, thereby streamlining the PQR report generation process.

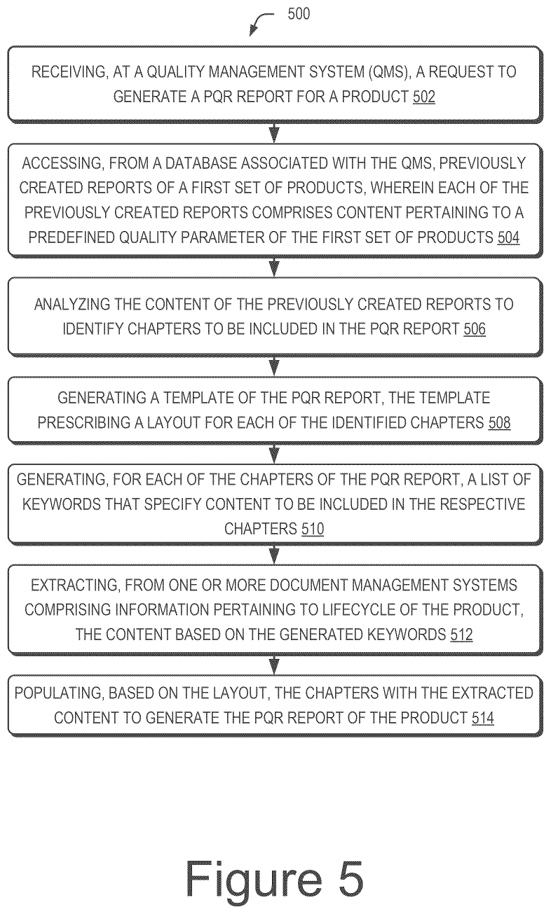

FIG. 5 illustrates a method 500 for generation of product quality review (PQR) report of a product or batches of products, according to an example implementation of the present subject matter. Although the method 500 may be implemented in a variety of computer-based systems, for ease of explanation, the present description of the example method 500 for the generation of the PQR report for the product is provided in reference to the above-described QMS 102.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof. The steps of the method 500 as well as other methods described herein may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, the method 500 may include receiving, for example at the QMS 102, a request to generate the PQR report for the product. In an example, the request may be received at the communication module 310 of the QMS 102 from the representative 108 of the manufacturer of the product, for example, through the user device 110. In an example, the request to generate the PQR report may be initiated to comply with the regulatory requirements associated with the product. As explained previously, amongst other workflows, the QMS 102 may implement one or more workflows to manage stages of the generation of the PQR report and to store, for example, in the QMS database 104 of the QMS 102, data generated at each of the stages of the generation of the PQR report which may be used in preparing the PQR report of the product.

At block 504, the method 500 may include accessing, from the database 104 associated with the QMS 102, previously created reports of a first set of products. In an example, the previously created reports may be accessed by the historic data module 202 of the QMS 102. In an example, each of the previously created reports may include content pertaining to a predefined quality parameter of the first set of products. This may be done analyze the previously created reports to identify if any content of the previously created reports corresponds to chapters or information that are required to be included in the PQR report of the product to comply with the regulatory requirements. To accomplish this, the historic data module 202 may employ various natural language processing (NLP) and machine learning techniques. For example, even if a section of the previously created report is not explicitly labeled as “stability studies” the historic data module 202 may identify content discussing long-term storage tests, accelerated stability data, or changes in product characteristics over time as relevant to the PQR report of the product. Similarly, the QMS 102 may recognize discussions about manufacturing deviations or quality control issues as relevant for the PQR report, regardless of how this information is labeled or organized in the previously created report.

At block 506, the method 500 may include analyzing the content of the previously created reports to identify relevant chapters for inclusion in the PQR report. In an example, each chapter of the PQR report may correspond to a predefined quality parameter of the product. The first LLM module 204 of the QMS 102 may be responsible for conducting this analysis. For example, the first LLM module 204 may analyze a recall investigation report from the first set of products and determine that certain content, such as root cause analysis findings, corrective and preventive actions (CAPA), or deviations in manufacturing processes, is relevant to the PQR report. Based on this analysis, the first LLM module 204 may categorize the extracted content under appropriate chapters, such as deviations and non-conformances, out-of-specification (OOS) results, or the like. If the recall investigation report highlights multiple instances of batch failures due to process deviations, the first LLM module 204 may determine that this content may be categorized under a “deviations and non-conformances” chapter in the PQR report. Similarly, if the recall investigation report mentions failed laboratory test results, impurity profile anomalies, or significant variations in assay values, the first LLM module 204 may categorize this information under an “out-of-specification (OOS) results” chapter. Thus, by analyzing the content of the previously created reports and mapping the information to predefined quality parameters, the QMS 102 may identify the chapters specific to the product that are to be included in the PQR report while eliminating the need for manual content review.

In an embodiment, the chapters that are identified by the first LLM module 204 to be relevant for the PQR report of the product may be confirmed by the representative 108 of the manufacturer based on determination of whether the identified chapters are to be included in the PQR report based on the regulatory requirements, in an example. For example, the representative 108 may review the chapters identified by the QMS 102 to be relevant for the PQR report and compare them against the regulatory requirements for PQR reports in pharmaceutical industry. The representative 108 may confirm the inclusion of chapters such as the “critical quality attributes” and “stability studies” as they are typically mandated by the regulatory authorities, such as the FDA, for the PQR reports of the pharmaceutical products. However, the representative 108 modify or exclude a chapter if it is not required to be included in the PQR report of the product under review or if recent regulatory changes have altered requirements for the PQR report of such product. Additionally, the representative 108 may identify the need for additional chapters not initially flagged by the QMS 102, such as a chapter on “post-market surveillance” if new pharmacovigilance requirements have been introduced for category of the product for which the PQR report is to be generated.

At block 508, the method 500 may include generating a template of the PQR report. In an example, the template may prescribe a layout for each of the identified chapters of the PQR report and may be generated by the first LLM module 204. For example, the template may specify the order of the chapters based on the format prescribed by regulatory authorities, such as placing “introduction and product overview” as the first chapter, followed by “manufacturing process summary,” “critical quality attributes,” “batch release data,” “stability studies,” “deviations and non-conformances,” “change controls,” “regulatory compliance,” and concluding with “conclusions and future Actions.” Within each chapter, the template may further define subsections and their order. For example, the “critical quality attributes” chapter may include subsections for each key attribute (e.g., assay, dissolution, impurity levels) in a specific sequence, with standardized formats for presenting historical data, trend analysis, and any deviations or out-of-specification results.

At block 510, the method 500 may include generating, for each of the chapters of the PQR report, a list of keywords that specify content to be included in the respective chapters. In an example, the list of keywords may be generated by the second LLM module 206 of the QMS 102. For example, for the “critical quality attributes” chapter, the list of keywords may include terms such as “assay,” “dissolution,” “impurity profile,” “particle size,” and “moisture content.” For the “stability studies” chapter, the list of keywords may include “long-term stability,” “accelerated stability,” “stress testing,” “shelf life,” and “storage conditions.” Similarly, the “deviations and non-conformances” chapter may have the keywords like “out-of-specification,” “root cause analysis,” “corrective actions,” and “preventive measures.”

At block 512, the method 500 may include extracting, from one or more document management systems (DMSs), such as the DMSs 114-1, 114-2, . . . , 114-N, including information pertaining to the lifecycle of the product, the content for the chapters of the PQR report based on the generated keywords. This extraction of the content may be done by the third LLM module 208 of the QMS.

At block 514, the method 500 may include populating, based on the layout, the chapters of the PQR report with the extracted content to generate the PQR report of the product. This may also be done by the third LLM module of the QMS 102.

Thus, the example method 500 streamlines the process of identifying the relevant content for generating the PQR report for the product. By leveraging previously created reports stored in data sources such as the database 104 associated with the QMS 102, the QMS 102 enhances operational efficiency, reduces manual effort, and ensures accurate and comprehensive PQR report generation. This automated approach improves compliance with the regulatory requirements, maintains consistency across reports, and enhances the overall effectiveness of the QMS 102.

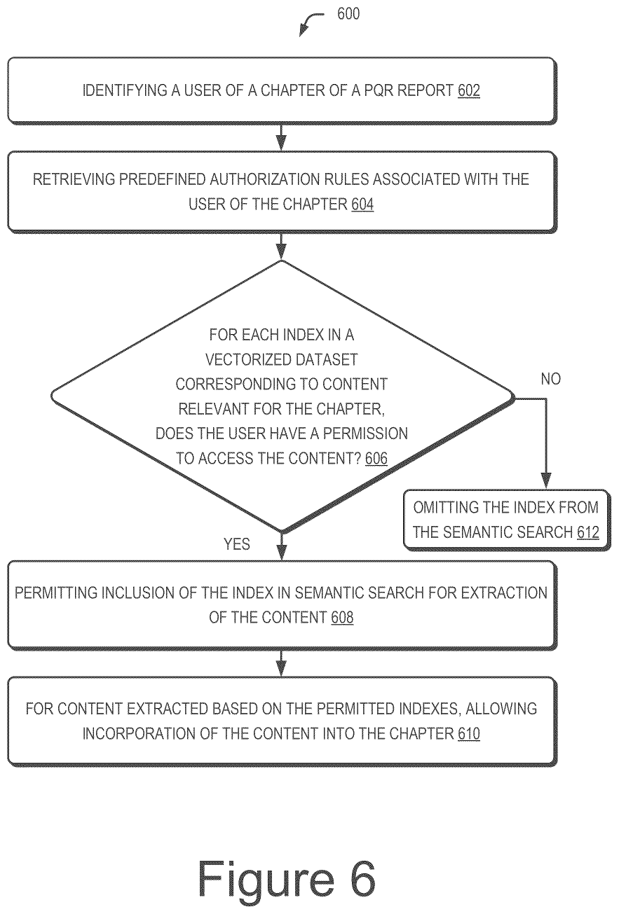

FIG. 6 illustrates a flow diagram of a process 600 for authenticating rights of a user to access content for a chapter of the PQE report from document management systems, such as the DMSs 114-1, 114-2, . . . , 114-N, according to an example implementation of the present subject matter. The order in which the above-mentioned process is described is not intended to be construed as a limitation, and some of the described process blocks may be combined in a different order to implement the process or an alternative process.

Furthermore, the above-mentioned process 600 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 600 may be implemented by the above-described QMS 102.

Referring to FIG. 6, at block 602, the process 600 may include identifying a user of a chapter of the PQR report. In an example, to identify the user of the chapter, credentials of the user may be used, for example, by the access control module 312. In an example, the credentials of the user may be stored in the QMS database 104 of the QMS 102. In an alternative embodiment, the credentials of the user may be stored in the corresponding DMS 114-1, 114-2, . . . , 114-N. At block 604, the process 600 may include retrieving predefined authorization rules associated with the user of the chapter.

At block 606, an assessment may be made to determine whether, for each index in the vectorized dataset corresponding to content relevant for the chapter, the user has the necessary permissions to access the content. As explained previously, the assessment may be performed by the access control module 312 of the QMS 102. In case the assessment is affirmative, indicating that the user has the permission to access the content of the index, the process 600 may proceed to block 608. At block 608, the process 600 may include permitting inclusion of the index in semantic search for extraction of the content. In an example, this permission may be granted by the access control module 312.

At block 610, the process 600 may include, for content extracted based on the permitted indexes, incorporation of the content into the chapter of the PQR report. In an example, the access control module 312 may allow the third LLM module 208 to incorporate the content of the permitted indexes into the corresponding chapters of the PQR report.

However, if at block 606, it is determined that the user does not have the necessary permissions to access the content of the index, the process 600 may proceed to block 612. At block 612, the process 600 may include omitting the index from the semantic search.

The QMS 102 thus ensures control over access to the information stored in the DMSs 114-1, 114-2, . . . , 114-N by preventing unauthorized users from retrieving or utilizing restricted information. By enforcing robust access control mechanisms, the QMS 102 verifies user permissions before granting access to the information within the DMSs 114-1, 114-2, . . . , 114-N, ensuring that only authorized personnel may retrieve or include specific information in the PQR report. This prevents unauthorized users from extracting proprietary or sensitive manufacturer data, thereby enhancing data security, reducing the risk of unauthorized disclosures, and ensuring compliance with organizational access policies and regulatory requirements.

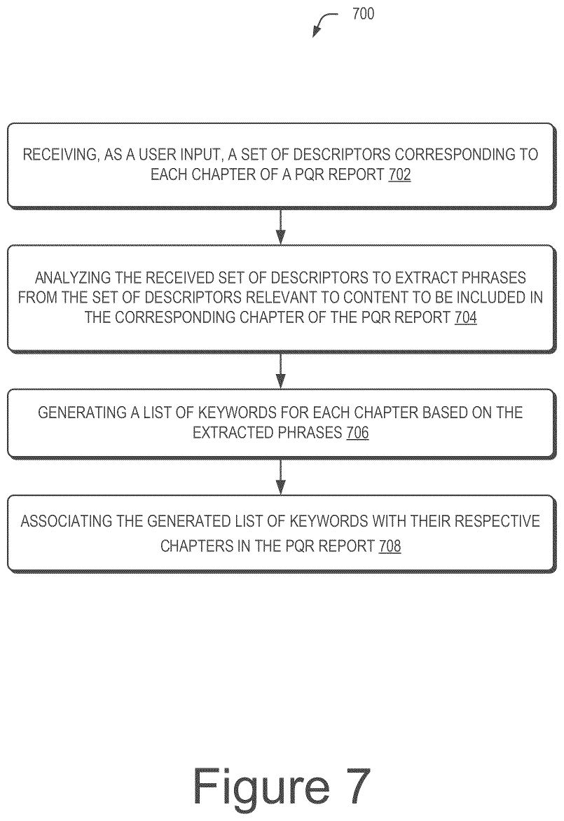

FIG. 7 depicts a flow diagram of a process 700 for generating, for each of the identified chapters of the PQR report, a list of keywords that specify the content to be included in the respective chapters of the PQR report, in accordance with an example implementation of the present subject matter. The order in which the above-mentioned process 700 is described is not intended to be construed as a limitation, and some of the described process blocks may be combined in a different order to implement the process, or an alternative process.

Furthermore, the above-mentioned process 700 may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 700 may be implemented by the above described QMS 102.

At block 702, the process 700 may include receiving, as a user input, a set of descriptors corresponding to each chapter of the PQR report. In an example, the set of descriptors may indicate key topics, parameters, or subject areas for which content is to be included in each chapter of the PQR report. The descriptors may be provided by users responsible for specific chapters of the PQR report. In an example, the descriptors may be received at the communication module 310 of the QMS 102 from the users with appropriate access privileges. For example, a user preparing the “deviations and non-conformances” chapter may input descriptors such as “identify manufacturing deviations,” “access out-of-spec results,” and “obtain corrective actions taken” to guide the content identification.

At block 704, the process 700 may include analyzing the received set of descriptors to extract key phrases that are relevant to the content to be included in the corresponding chapter of the PQR report. In an example, the second LLM module 206 may be trained, for example, on the natural language processing (NLP) techniques, to parse the descriptors, identify semantically relevant terms, and filter out generic or redundant phrases. For example, if the received descriptors for the “stability studies” chapter include “identify long-term stability,” “identify accelerated stability,” and “what is shelf-life assessment,” the analysis may refine these into key phrases such as “stability testing data,” “storage condition impact,” and “expiration date trends” to optimize content retrieval.

At block 706, the process 700 may include generating the list of keywords for each chapter based on the extracted phrases. In an example, the second LLM module 206 may use the extracted phrases to generate the relevant keywords for each chapter of the PQR report. For example, for the “critical quality attributes” chapter, the list of keywords generated by the second LLM module 206 may include terms such as “assay,” “dissolution,” “impurity profile,” “particle size,” and “moisture content.” For the “stability studies” chapter, the list of keywords may include “long-term stability,” “accelerated stability,” “stress testing,” “shelf life,” and “storage conditions.” Similarly, the “deviations and non-conformances” chapter may have keywords like “out-of-specification,” “root cause analysis,” “corrective actions,” and “preventive measures.”

At block 708, the process 700 may include associating the generated list of keywords with their respective chapters in the PQR report. This may be done by the second LLM module 206 so that during content extraction for the chapters of the PQR report that associated keywords may be used.

Using the keywords to extract relevant content for the chapters of the PQR report may ensure context-aware content retrieval, allowing the QMS 102 to intelligently identify and categorize relevant content for each chapter of the PQR report. By analyzing descriptors and generating contextually appropriate keywords, the QMS 102 may enhance accuracy, consistency, and efficiency in populating the PQR report, ensuring that only relevant content is included while minimizing manual effort and errors.

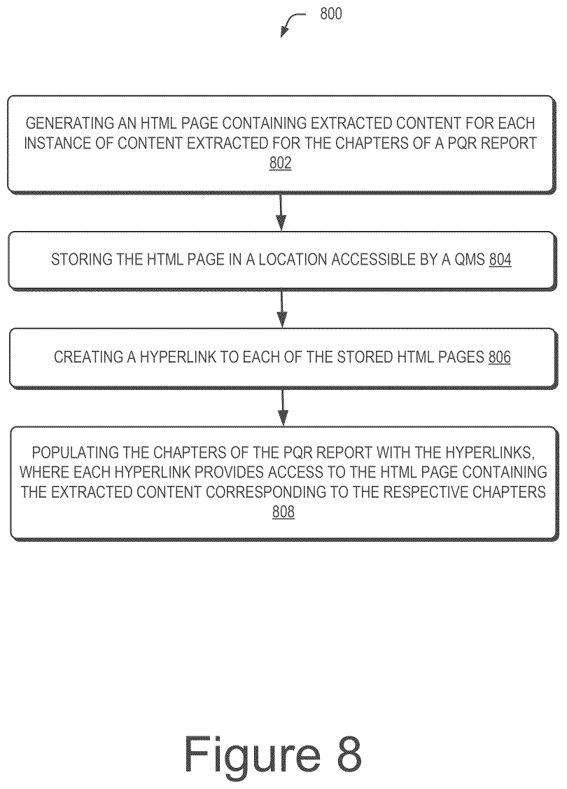

FIG. 8 illustrates a process 800 for providing access to the content extracted for the chapters of the PQR report through hyperlinks, according to an example implementation of the present subject matter.

The order in which the above-mentioned process 800 is described is not intended to be construed as a limitation, and some of the described process blocks may be combined in a different order to implement the process, or an alternative process.

Furthermore, the above-mentioned process 800 may be implemented in a suitable hardware, computer-readable instructions, or a combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 800 may be implemented by the above described QMS 102.

As explained previously, in some cases, instead of displaying content within a chapter of the PQR report, direct access to the original content may be needed for authenticity and traceability. Regulatory audits or quality reviews may require supporting evidence like source documents or test reports. Providing access ensures transparency, accuracy, and compliance while allowing users to verify information at its source. Additionally, storing frequently referenced content separately and linking it, rather than duplicating it across chapters, improves efficiency and consistency.

Accordingly, referring to FIG. 800, at block 802, the process 800 may include generating an HTML page containing extracted content for each instance of content extracted for the chapters of the PQR report.

At block 804, the process 800 may include storing the HTML page in a location, for example, in the corresponding DMS 114-1, 114-2, . . . , 114-N from where the content is extracted, accessible by the QMS 102.

At block 806, the process 800 may include creating a hyperlink to each of the stored HTML pages.

At block 808, the process 800 may include populating the chapters of the PQR report with the hyperlinks. In an example, each hyperlink may provide access to the HTML page containing the extracted content corresponding to the respective chapters. In an example, this process be implemented by the third LLM module 208.

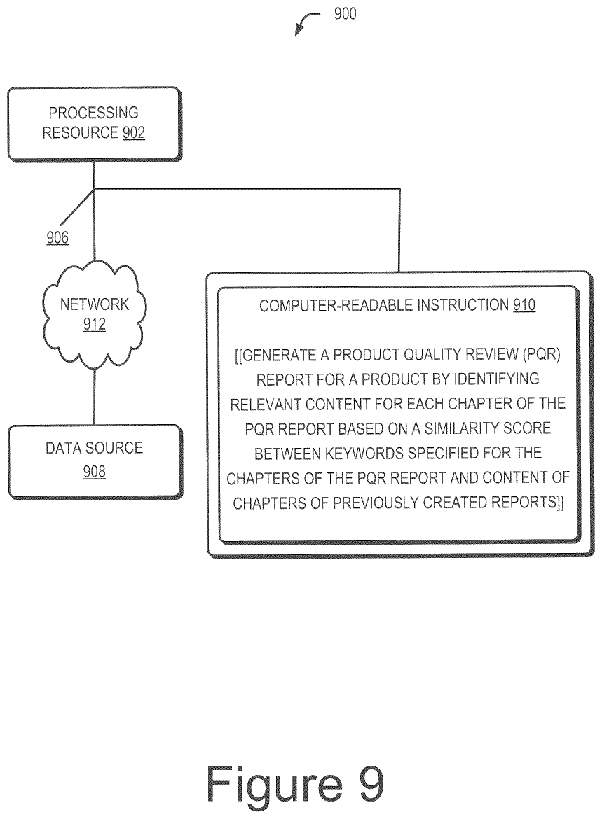

FIG. 9 illustrates a computing environment 900 for generating a product quality review (PQR) report for a product or batches of the product, according to an example implementation of the present subject matter. In an example implementation, the computing environment 900 may include a computing device, such as the above-described QMS 102. The computing environment 900 includes a processing resource 902 communicatively coupled to the non-transitory computer-readable medium 904 through a communication link 906.

In an example, the processing resource 902 may be a processor of the computing device, such as the processor 302 of the QMS 102, that fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 can access the non-transitory computer-readable medium 904 through a network 912. The network 912 may be a single network or a combination of multiple networks and may use a variety of different communication protocols.

The processing resource 902 and the non-transitory computer-readable medium 904 may also be communicatively coupled to data sources 908. In an example implementation, the non-transitory computer-readable medium 904 includes executable instructions 910 for optimizing the process of generation the PQR report of the product. Optimization of the generation of the PQR report is done to enhance efficiency, reduce manual intervention, and ensure compliance with regulatory requirements. This may include streamlining data retrieval, automating content structuring, and intelligently mapping relevant information to the appropriate chapters, thereby improving accuracy and consistency in the PQR report generation.

In an embodiment, the instructions 910 may cause the processing resource 902 to define, upon receiving a request to generate a PQR report for a product, a template for the PQR report. In an example, the template may include one or more chapters, each structured to organize specific quality-related information of the product in accordance with the regulatory guidelines and internal quality management requirements. In an example, the template may be defined based on a type of the product and regulatory requirements associated with the type of the product. In an example, each chapter of the PQR report may include content pertaining to a predefined quality parameter corresponding to the product, such as manufacturing consistency, stability studies, deviations, corrective and preventive actions (CAPA), and change controls. For example, a chapter on “stability studies” may include content regarding the shelf life of the product, storage conditions, and observed trends over multiple batches. By structuring the template in this manner, the present subject matter ensures that the PQR report captures all essential quality attributes of the product while maintaining compliance with the regulatory requirements and facilitating efficient review processes.

In an embodiment, the instructions 910 may cause the processing resource 902 to generate, for each of the chapters of the PQR report, a list of keywords that specify the content to be included in the respective chapters. In an example, to generate the list of keywords, the processing resource 902 may receive, as user input, a set of descriptors corresponding to each chapter of the PQR report. The processing resource 902 may then analyze the received descriptors to extract key phrases that are relevant to the content of the respective chapter. Furthermore, based on the extracted phrases, the processing resource 902 may generate a list of keywords for each chapter, ensuring that the content included in the PQR report aligns with predefined quality parameters and regulatory requirements. For example, if a chapter pertains to deviations, the descriptors may include terms such as “batch discrepancies,” “out-of-specification (OOS) events,” and “corrective actions.” The processing resource 902 may analyze these descriptors and generate a list of keywords such as “deviation management,” “root cause analysis,” “impact assessment,” and “regulatory compliance,” which may guide the content selection process for that chapter.

In an embodiment, the processing resource 902 may receive user input, for example, from users corresponding to the respective chapters, to confirm the list of keywords generated for the chapters based on the extracted phrases. The users may review, validate, and, if necessary, modify the keywords to ensure accuracy and relevance to the content requirements of the specific chapters. For example, if the processing resource 902 generates a list of keywords for a chapter related to the “stability studies”, a user responsible for that chapter may review the list of keywords and refine the list of keywords, for example, by adding or removing keywords such as “long-term stability,” “accelerated stability testing,” or “shelf-life determination” to better align with the regulatory requirement and internal guidelines.

In an embodiment, the instructions 910 may cause the processing resource 902 to access from one or more data sources, such as the data sources 112-1, 112-2, . . . , and 112-N, previously created reports of a first set of products. In an example, the data sources 112-1, 112-2, . . . , and 112-N may include the QMS 102 that implements one or more workflows to control manufacturing of the product. In an example, each of the previously created reports may include a plurality of chapters and each chapter may include content pertaining to a predefined quality parameter of the first set of products. In an embodiment, the instructions 910 may cause the processing resource 902 to further determine a similarity score between the keywords of the chapters of the PQR report and the content of the chapters of at least one of the previously created reports from the first set of products. The similarity score may be indicative of the degree to which the keywords of the chapters in the PQR report are associated with the content of the corresponding chapters in the previously created report. For example, if the PQR report includes a chapter on “process validation,” the processing resource 902 may compare the keywords of this chapter with the content of similar chapters in the previously created report of the first set of products, such as those within the same broad category of medical formulations. If the similarity score exceeds a predetermined threshold, the processing resource 902 may identify the corresponding chapter from the previously created report as a relevant reference.

In an embodiment, the instructions 910 may cause the processing resource 902 to retrieve a hyperlink associated with the identified chapter of the previously created report and populate the chapter of the PQR report with the retrieved hyperlink. In an example, the hyperlink provides access to an HTML page containing the content relevant to the chapter of the PQR report.

In an embodiment, the instructions 910 may cause the processing resource 902 to control access to each chapter of the PQR report by one or more users based on predefined authorization rules.

Thus, the present subject matter provides for optimizing the generation of the PQR report by automating content retrieval, structuring, and validation processes, for example, using the large language models. Although implementations of this optimization technique have been described in language specific to structural features and/or methods, it is to be understood that the appended claims are not necessarily limited to the specific features or methods described. Rather, the specific features and methods are disclosed as example implementations of an optimized approach for generating the PQR reports, ensuring efficiency, accuracy, and compliance with the regulatory requirements

1. A quality management system (QMS), comprising:
one or more processors;
a historic data module, coupled to the one or more processors, to:
retrieve, from one or more data sources, previously created reports pertaining to lifecycle of a first set of products, wherein each of the previously created reports comprises a plurality of chapters, each chapter comprising content pertaining to a predefined quality parameter of the first set of products;
a first large language model (LLM) module, coupled to the one or more processors, to:
analyze the plurality of chapters of the previously created reports to identify one or more chapters from amongst the plurality of chapters to be included in a product quality review (PQR) report of a product, and
generate a template of the PQR report, the template prescribing a layout for each of the identified chapters;
a second LLM module coupled to the one or more processors, to generate, for each of the identified chapters of the PQR report, a list of keywords that specify content to be included in the respective chapters;
a third LLM module coupled to the one or more processors, to:
extract, from one or more document management systems (DMSs) comprising information pertaining to lifecycle of the product, the content based on the generated keywords; and
map the extracted content to the respective chapters based on the layout to populate each of the identified chapters to generate the PQR report of the product.

2. The QMS of claim 1, wherein the third LLM module is further to:
access, from the one or more DMSs, the information pertaining to the lifecycle of the product; and
convert the information accessed from the one or more DMSs into a vectorized dataset; and
query the vectorized dataset to extract the content relevant to the identified chapters of the PQR report based on a semantic similarity between the vectorized dataset and the keywords specifying the content to be included in the respective chapters.

3. The QMS of claim 1, further comprising an access control module coupled to the one or more processors, to control access to each chapter of the PQR report by one or more users based on predefined authorization rules.

4. The QMS of claim 3, wherein the access control module is to further control access to the information in the DMSs by the one or more users based on the predefined authorization rules.

5. The QMS of claim 1, wherein the third LLM module is further to:
generate, for each instance of the content extracted for the identified chapters, an HTML page containing the extracted content;
store the HTML page corresponding to the extracted content in a location accessible by the QMS;
create a hyperlink to each of the stored HTML page; and
populate the identified chapters with one or more hyperlinks, wherein each hyperlink provides access to the HTML page containing the extracted content corresponding to the respective chapters.

6. The QMS of claim 1, wherein, to generate the list of keywords, the second LLM is to:
receive, as a user input, a set of descriptors corresponding to each chapter of the PQR report;
analyze the received set of descriptors to extract phrases from the set of descriptors relevant to the content to be included in the corresponding chapter; and
generate the list of keywords for each chapter based on the extracted phrases.

7. The QMS of claim 1, wherein to generate the PQR report for the product, the third LLM module is further configured to:
determine a similarity score between the keywords of the identified chapters of the PQR report and content of the chapters of at least one of the previously created reports of the first set of products, wherein the similarity score is indicative of a degree to which the keywords of the chapters of the PQR report are associated with the content of the corresponding chapters of the previously created report;
identify a chapter from the previously created report with a similarity score exceeding a predetermined threshold;
retrieve a hyperlink associated with the identified chapter of the previously created report; and
populate the chapter of the PQR report with the retrieved hyperlink, wherein the hyperlink provides access to an HTML page containing content relevant to the chapter of the PQR report.

8. A method for generating a product quality review (PQR) report, comprising:
receiving, at a quality management system (QMS), a request to generate the PQR report for a product;
accessing, from a database associated with the QMS, previously created reports of a first set of products, wherein each of the previously created reports comprises content pertaining to a predefined quality parameter of the first set of products;
analyzing the content of the previously created reports to identify chapters to be included in the PQR report;
generating a template of the PQR report, the template prescribing a layout for each of the identified chapters;
generating, for each of the chapters of the PQR report, a list of keywords that specify content to be included in the respective chapters;
extracting, from one or more document management systems (DMSs) comprising information pertaining to lifecycle of the product, the content based on the generated keywords; and
populating, based on the layout, the chapters with the extracted content to generate the PQR report of the product.

9. The method of claim 8, further comprising:
accessing, from the one or more DMSs, the information pertaining to the lifecycle of the product; and
converting the information accessed from the one or more DMSs into a vectorized dataset; and
querying the vectorized dataset to extract the content relevant to the chapters of the PQR report based on a semantic similarity between the vectorized dataset and the keywords specifying the content to be included in the respective chapters.

10. The method of claim 8, further comprising controlling access to each chapter of the PQR report by one or more users based on predefined authorization rules.

11. The method of claim 8, further comprising controlling access to the information in the one or more DMSs by the one or more uses based on the predefined authorization rules.

12. The method of claim 8, further comprising:
generating, for each instance of the content extracted for the chapters of the PQR report, an HTML page containing the extracted content;
storing the HTML page in a location accessible by the QMS;
creating a hyperlink to each of the stored HTML page; and
populating the chapters of the PQR report with the hyperlink, wherein each hyperlink provides access to the HTML page containing the extracted content corresponding to the respective chapters.

13. The method of claim 8, wherein generating the list of keywords comprises:
receiving, as a user input, a set of descriptors corresponding to each chapter of the PQR report;
analyzing the received set of descriptors to extract phrases from the set of descriptors relevant to the content to be included in the corresponding chapter; and
generating the list of keywords for each chapter based on the extracted phrases.

14. The method of claim 8, further comprising receiving a user input to modify the chapters identified to be included in the PQR report.

15. A non-transitory computer-readable medium comprising instructions executable by a processing resource to:
define, upon receiving a request to generate a product quality (PQR) report for a product, a template for the PQR report, wherein the template comprises one or more chapters, each chapter is to include content pertaining to a predefined quality parameter corresponding to the product;
generate, for each of the chapters of the PQR report, a list of keywords that specify the content to be included in the respective chapters;
access, from one or more data sources, previously created reports of a first set of products, wherein each of the previously created reports comprises a plurality of chapters, each chapter comprising content pertaining to a predefined quality parameter of the first set of products;
determine a similarity score between the keywords of the chapters of the PQR report and content of the chapters of at least one of the previously created reports of the first set of products, the similarity score being indicative of a degree to which the keywords of the chapters of the PQR report are associated with the content of the corresponding chapters of the previously created report;
identify a chapter from the previously created report with a similarity score exceeding a predetermined threshold;
retrieve a hyperlink associated with the identified chapter of the previously created report; and
populate the chapter of the PQR report with the retrieved hyperlink, wherein the hyperlink provides access to an HTML page containing the content relevant to the chapter of the PQR report.

16. The non-transitory computer-readable medium of claim 15, wherein to generate the list of keywords, the processing resource is to:
receive, as a user input, a set of descriptors corresponding to each chapter of the PQR report;
analyze the received set of descriptors to extract phrases from the set of descriptors relevant to the content to be included in the corresponding chapter; and
generate a list of keywords for each chapter based on the extracted phrases.

17. The non-transitory computer-readable medium of claim 16, further comprising instructions executable by the processing resource to receive a user input to confirm the list of keywords generated based on the extracted phrases.

18. The non-transitory computer-readable medium of claim 15, further comprising instructions executable by the processing resource to control access to each chapter of the PQR report by one or more users based on predefined authorization rules.

19. The non-transitory computer-readable medium of claim 15, wherein the template is defined based on at least one of a type of the product and regulatory requirements associated with the type of the product.

20. The non-transitory computer-readable medium of claim 15, wherein the one or more data sources comprises a quality management system (QMS) that implements one or more workflows to control manufacturing of the product.
